(19) United States
(12) Patent Application Publication
(10) Pub. No.: US 2018/0358647 A1
(43) Pub. Date: Dec. 13, 2018

(54) LITHIUM SECONDARY BATTERY INCLUDING PHOSPHATE-BASED ADDITIVE

(71) Applicants: Samsung Electronics Co., Ltd., Suwon-si (KR); Samsung SDI Co., Ltd., Yongin-si (KR)

(72) Inventors: Myongchun KOH, Hwaseong-si (KR); Insun PARK, Suwon-si (KR); Hosang PARK, Seoul (KR); Jinah SEO, Seoul (KR); Yeonji CHUNG, Yongin-si (KR)

(21) Appl. No.: 15/991,124

(22) Filed: May 29, 2018

(30) Foreign Application Priority Data
Jun. 12, 2017 (KR) 10-2017-0073290

(51) Int. Cl. H01M 10/052; H01M 10/0569; H01M 10/0567; H01M 4/133; H01M 4/131; H01M 4/134; H01M 4/66; H01M 4/58

(52) U.S. Cl. CPC H01M 10/052; H01M 10/0569; H01M 10/0567; H01M 4/133; H01M 2004/027; H01M 4/134; H01M 4/661; H01M 4/5825; H01M 4/131

(57) ABSTRACT

A lithium secondary battery includes: a positive electrode; a negative electrode; and an electrolyte disposed between the positive electrode and the negative electrode, wherein the positive electrode includes a positive active material represented by Formula 1, the electrolyte includes a lithium salt, a non-aqueous solvent, and a phosphate compound represented by Formula 2, and an amount of the phosphate compound is less than about 3 weight percent based on a total weight of the electrolyte,

LiₓNi_{y}M_{1-y}O_{2-z}A_{z} Formula 1

wherein, in Formula 1, 0.9≤x≤1.2, 0.7≤y≤0.98, and 0≤z<0.2, M comprises Al, Mg, Mn, Co, Fe, Cr, V, Ti, Cu, B, Ca, Zn, Zr, Nb, Mo, Sr, Sb, W, Bi, or a combination thereof, and A is an element having an oxidation number of −1 or −2,

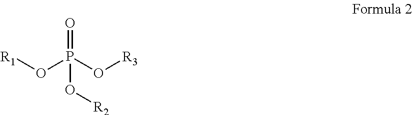

wherein, in Formula 2, R₁ to R₃ are each independently an unsubstituted linear or branched C₁-C₃₀ alkyl group or an unsubstituted C₆-C₆₀ aryl group.

### CROSS-REFERENCE TO RELATED APPLICATION

This application claims priority to and the benefit of Korean Patent Application No. 10-2017-0073290, filed on Jun. 12, 2017, in the Korean Intellectual Property Office, and all the benefits accruing therefrom under 35 U.S.C. § 119, the content of which is incorporated herein by reference in its entirety.

### BACKGROUND

### 1. Field

The present disclosure relates to a lithium secondary battery including a phosphate-based additive.

### 2. Description of the Related Art

Lithium secondary batteries are used as power sources for portable electronic devices, such as camcorders, mobile phones, and laptop computers. Lithium secondary batteries are rechargeable at high rates and have an energy density which is about three times greater than the energy density of a lead storage battery, a nickel-cadmium (Ni—Cd) battery, a nickel-hydrogen battery, or a nickel-zinc battery.

A positive active material in a positive electrode of lithium secondary batteries is a lithium-containing metal oxide. For example, a composite oxide of lithium and a metal selected from cobalt, manganese, nickel (Ni), or a combination thereof may be used as a positive active material. Positive active materials containing a large amount of Ni can be used to provide a battery having greater capacity than a battery including a lithium-cobalt oxide. Thus, a positive active material containing a large amount of nickel is a desirable alternative for a lithium secondary battery.

However, when the amount of Ni in the positive active material is too high, the surface of the positive active material may have a weak structure, and resulting in a battery having poor lifespan characteristics and increased resistance.

Therefore, there is a need for a lithium secondary battery which includes a positive active material which exhibit increased capacity, excellent lifespan characteristics, and low resistance.

### SUMMARY

Provided is a lithium secondary battery having an improved structure.

According to an aspect of an embodiment, a lithium secondary battery includes: a positive electrode; a negative electrode; and an electrolyte disposed between the positive electrode and the negative electrode, wherein the positive electrode includes a positive active material represented by Formula 1, the electrolyte includes a lithium salt, a non-aqueous solvent, and a phosphate compound represented by Formula 2, and an amount of the phosphate compound is less than about 3 weight percent (wt %) based on a total weight of the electrolyte,

LiₓNi_{y}M_{1-y}O_{2-z}A_{z} Formula 1

wherein, in Formula 1,

0.9≤x≤1.2, 0.7≤y≤0.98, and 0≤z<0.2,

M comprises Al, Mg, Mn, Co, Fe, Cr, V, Ti, Cu, B, Ca, Zn, Zr, Nb, Mo, Sr, Sb, W, Bi, or a combination thereof, and

A is an element having an oxidation number of −1 or −2,

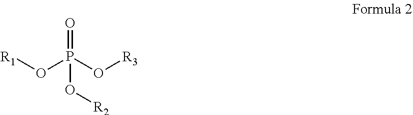

wherein, in Formula 2,

R₁ to R₃ are each independently an unsubstituted linear or branched C₁-C₃₀ alkyl group or an unsubstituted C₆-C₆₀ aryl group.

Additional aspects will be set forth in part in the description which follows and, in part, will be apparent from the description, or may be learned by practice of the presented embodiments.

### DETAILED DESCRIPTION

Reference will now be made in detail to various embodiments. In this regard, the present embodiments may have different forms and should not be construed as being limited to the descriptions set forth herein. Accordingly, the embodiments are merely described below, to explain aspects.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” As used herein, the term “and/or” includes any and all combinations of one or more of the associated listed items. Expressions such as “at least one of,” when preceding a list of elements, modify the entire list of elements and do not modify the individual elements of the list.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, a lithium secondary battery according to an embodiment will be described in further detail.

The lithium secondary battery according to an embodiment includes a positive electrode; a negative electrode; and an electrolyte disposed between the positive electrode and the negative electrode, wherein the positive electrode includes a positive active material represented by Formula 1, the electrolyte includes a lithium salt, a non-aqueous solvent, and a phosphate compound represented by Formula 2, and an amount of the phosphate-based compound is less than about 3 wt % based on the total weight of the electrolyte:

LiₓNi_{y}M_{1-y}O_{2-z}A_{z} Formula 1

wherein, in Formula 1,

0.9≤x≤1.2, 0.7≤y≤0.98, and 0≤z<0.2,

M includes Al, Mg, Mn, Co, Fe, Cr, V, Ti, Cu, B, Ca, Zn, Zr, Nb, Mo, Sr, Sb, W, Bi, or a combination thereof; and

A is an element having an oxidation number of −1 or −2,

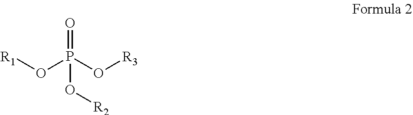

wherein in Formula 2, R₁ to R₃ are each independently an unsubstituted linear or branched C₁-C₃₀ alkyl group or an unsubstituted C₆-C₆₀ aryl group.

Despite the advantage of manufacturing a high capacity battery, a lithium metal composite oxide containing a large amount of Ni may have problems such as severe deterioration in the battery lifespan characteristics, for example, deterioration of a capacity retention or a resistance increase rate, and thus the lithium metal composite oxide containing a large amount of Ni has not been commercialized. Without being limited by theory, it is believed that the deterioration in capacity retention and resistance increase may be caused by the release of cation Ni³⁺ into the electrolyte from the positive electrode and/or by disproportionation that results in some of the cation Ni³⁺ becoming Ni⁴⁺ during discharging of the battery and the production of NiO. Due to these problems, battery lifespan characteristics may be deteriorated, and resistance may increase. To address these problems, a structure of the lithium secondary battery in some embodiments includes an electrolyte including the phosphate-based compound represented by Formula 2, which protects the cation Ni³⁺, and thus the elution of the cation Ni³⁺ and the disproportionation may be prevented.

In particular, without being limited by theory, it is understood that the phosphate-based compound has a high affinity with the cation Ni³⁺, and thus inhibits side reactions of the cation Ni³⁺. Also, even in a battery that is operated at a high voltage, high affinity of the phosphate compound with the cation Ni³⁺ may be maintained, and through this, the elution of the cation Ni³⁺ or the oxidation and disproportionation of becoming Ni⁴⁺ may be suppressed.

Here, the phosphate-based compound may be included in the electrolyte in an amount of less than about 3 wt % based on the total weight of the electrolyte. However, embodiments are not limited thereto, and the amount of the phosphate compound may be in any range that is capable of maintaining battery lifespan characteristics by protecting Ni³⁺. When the amount of the phosphate-based compound is greater than about 3 wt %, significant self-decomposition of the phosphite-based compound may occur, which may result in an increase in film resistance and deterioration of the battery capacity, storage stability, and cycle characteristics, and thus an amount of greater than about 3 wt %, based on a total weight of the electrolyte is not suitable.

For example, the amount of the phosphate-based compound may be in a range of about 0.1 wt % or greater to less than about 3 wt % based on the total weight of the electrolyte. For example, the amount of the phosphate-based compound may be in a range of about 0.1 wt % or greater to about 2 wt % or less based on the total weight of the electrolyte. For example, an amount of the phosphate-based compound may be in a range of about 0.2 wt % or greater to about 2 wt % or less based on the total weight of the electrolyte. For example, an amount of the phosphate-based compound may be in a range of about 1 wt % or greater to about 2 wt % or less based on the total weight of the electrolyte.

When an amount of the phosphate-based compound is lower than about 0.1 wt %, the amount may be too small to form a protective layer, and sufficient resistance decreasing effects may not be obtained.

In an embodiment, R₁ to R₃ may each independently be an unsubstituted linear or branched C₁-C₃₀ alkyl group or an unsubstituted C₆-C₆₀ aryl group.

The C₁-C₃₀ alkyl group may be, for example, a methyl group, an ethyl group, a propyl group, an isopropyl group, a butyl group, a sec-butyl group, a tert-butyl group, or an isobutyl group, but embodiments are not limited thereto.

The C₆-C₆₀ aryl group may be, for example, a phenyl group, a biphenyl group, or a tertphenyl group, but embodiments are not limited thereto.

In an embodiment, the phosphite-based compound may include trimethyl phosphate (TMP), triethyl phosphate (TEP), 2,2,2-trifluoroethylphosphate (TFEP), 3,3,3,2,2-pentafluoropropylphosphate, triphenyl phosphate (TPP), or a combination thereof.

The electrolyte includes a lithium salt. The lithium salt may be dissolved in an organic solvent and thus may serve as a source of lithium ions in a battery and, for example, may facilitate migration of lithium ions between the positive electrode and the negative electrode.

An anion of the lithium salt included in the electrolyte may include PF₆⁻, BF₄⁻, SbF₆⁻, AsF₆⁻, C₄F₉SO₃⁻, ClO₄⁻, AlO₂⁻, AlCl₄⁻, CₓF₂ₓ₊₁SO₃⁻ (where, x is a natural number), (CₓF₂ₓ₊₁SO₂)(C_{y}F_{2y+1}SO₂)N⁻ (where, x and y are a natural number), a halide, or a combination thereof.

For example, the lithium salt may include lithium difluoro(oxalato)borate (LiDFOB), lithium bis(oxalato)borate (LiBOB), lithium difluorooxalate phosphate (LiDFOP), LiBF₄, LiPF₆, LiCF₃SO₃, (CF₃SO₂)₂NLi, (FSO₂)₂NLi, or a combination thereof. For example, the lithium salt may be LiPF₆. The structure of lithium difluoro(oxalato)borate (LiDFOB) is illustrated below.

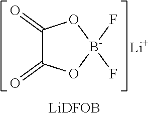

Also, the lithium salt may include a plurality of salts and, for example, may include LiPF₆ at a concentration in a range of about 0.6 molar (M) to about 2.0 M as a main salt and other salts such as LiDFOB, LiBOB, LiDFOP, LiBF₄, LiPF₆, LiCF₃SO₃, (CF₃SO₂)₂NLi, and (FSO₂)₂Ni in an amount not exceeding that of the main salt.

In particular, the lithium salt may include LiPF₆ at a concentration in a range of about 1 M to about 1.5 M as a main salt and LiDFOB, LiBOB, LiDFOP, LiBF₄, LiPF₆, LiCF₃SO₃, (CF₃SO₂)₂NLi, and (FSO₂)₂Ni at an amount in a range of about 0.5 wt % to about 10 wt % based on the total weight of the electrolyte.

For example, the non-aqueous solvent may include a carbonate-based solvent, an ester-based solvent, a ketone-based solvent, an aprotic solvent, or a combination thereof. Examples of the carbonate-based solvent may include dimethyl carbonate (DMC), diethyl carbonate (DEC), ethyl methyl carbonate (EMC), dipropyl carbonate (DPC), methyl propyl carbonate (MPC), ethyl propyl carbonate (EPC), methyl ethyl carbonate (MEC), ethylene carbonate (EC), propylene carbonate (PC), butylene carbonate (BC), or a combination thereof; and examples of the ester-based solvent may include methyl acetate, ethyl acetate, n-propyl acetate, dimethyl acetate, methyl propionate, ethyl propionate, γ-butyrolactone, decanolide, valerolactone, mevalonolactone, caprolactone, or a combination thereof.

The aprotic solvent may be used alone or as a combination of one or more aprotic solvents, and when the aprotic solvent is a combination of one or more aprotic solvents, the amounts of each solvent may be appropriately controlled, according to desired battery performance, and may be determined by one of ordinary skill in the art without undue experimentation.

The carbonate-based solvent may be a combination of a linear carbonate and a cyclic carbonate. In this case, the volume ratio of the linear carbonate to the cyclic carbonate may be in a range of about 1:1 to about 1:9, to obtain excellent electrolyte performance.

In some embodiments, the non-aqueous solvent may further include fluoro-ethylene carbonate (FEC), vinylene carbonate (VC), vinyl ethylene carbonate (VEC), a phosphorus (P)-containing compound, a sulfur (S)-containing compound, or a combination thereof.

For example, the non-aqueous solvent may include FEC. For example, the non-aqueous solvent may include FEC in an amount in a range of about 0.1 volume percent (vol %) to about 10 vol % based on the total volume of the non-aqueous solvent. For example, the non-aqueous solvent may include FEC in an amount in a range of about 0.5 vol % to about 7 vol % based on the total volume of the non-aqueous solvent. For example, the non-aqueous solvent may include FEC in an amount in a range of about 1 vol % to about 7 vol % based on the total volume of the non-aqueous solvent. For example, the non-aqueous solvent may include FEC in an amount in a range of about 2 vol % to about 7 vol % based on the total volume of the non-aqueous solvent. When the amount of FEC included in the non-aqueous solvent is an amount within the above-described ranges, an effective solid electrolyte interface (SEI) film, e.g., a SEI that does not degrade a diffusion ratio of lithium ions, may be formed in a short period of time.

The electrolyte may include a carbonate including a carbon-carbon single bond, a carbon-carbon double bond or a carbon-carbon triple bond, a carboxylic acid anhydride including a carbon-carbon single, a carbon-carbon double bond or a carbon-carbon triple bond, or a combination thereof. The carbonate and/or carboxylic acid anhydride may be linear or cyclic.

For example, the electrolyte may further include VC, VEC, maleic anhydride, succinic anhydride, or a combination thereof. For example, the lithium secondary battery may further include VC, VEC, maleic anhydride, succinic anhydride, or a combination thereof in an amount in a range of about 0.1 wt % to about 3 wt % based on the total weight of the electrolyte. For example, the lithium secondary battery may further include VC, VEC, maleic anhydride, succinic anhydride, or a mixture thereof in an amount in a range of about 0.1 wt % to about 2 wt % based on the total weight of the electrolyte.

In some embodiments, the electrolyte may further include maleic anhydride, but embodiments are not limited thereto. For example, the lithium secondary battery may further include maleic anhydride in an amount in a range of about 0.1 wt % to about 1.5 wt % based on the total weight of the electrolyte. For example, the lithium secondary battery may further include maleic anhydride in an amount in a range of about 0.1 wt % to about 1.0 wt % based on the total weight of the electrolyte. For example, the lithium secondary battery may further include maleic anhydride in an amount in a range of about 0.1 wt % to about 0.5 wt % based on the total weight of the electrolyte.

For example, the electrolyte may further include a phosphorous-containing compound, a sulfur-containing compound, or a combination thereof. For example, the electrolyte may further include a phosphorous-containing compound, a sulfur-containing compound, or a combination thereof in an amount of about 4 wt % or less. For example, the electrolyte may further include a phosphorous-containing compound, a sulfur-containing compound, or a combination thereof in an amount in a range of about 0.1 wt % or greater to about 3 wt % or less based on the total weight of the electrolyte. For example, the electrolyte may further include a phosphorous-containing compound, a sulfur-containing compound, or a combination thereof in an amount in a range of about 0.1 wt % or greater to about 2 wt % or less based on the total weight of the electrolyte. For example, the electrolyte may further include a phosphorous-containing compound, a sulfur-containing compound, or a combination thereof in an amount in a range of about 0.5 wt % to about 2 wt % based on the total weight of the electrolyte.

The phosphorous-containing compound may include a phosphine compound, a phosphite compound, or a combination thereof, and the sulfur-containing compound may include a sulfone compound, a sulfonate compound, a disulfonate compound, or a combination thereof.

For example, the electrolyte may not include a phosphorous-containing compound. In some embodiments, the electrolyte may not include a phosphite compound.

In some embodiments, examples of the phosphine compound may include triphenylphosphine, tris(o-tolyl)phosphine, or tris(butyl)phosphine, but embodiments are not limited thereto. Examples of the phosphite compound may include triethylphosphite (TEPi), trimethylphosphite, tripropylphosphite, tributylphosphite, tris(trimethylsilyl)phosphite, triphenylphosphite, or a combination thereof, but embodiments are not limited thereto.

Examples of the sulfone compound may include ethyl methyl sulfone, divinyl sulfone, tetramethylene sulfone, bisphenylsulfone, or a combination thereof, but embodiments are not limited thereto. Examples of the sulfonate compound may include methyl methane sulfonate, ethyl methane sulfonate, diallyl sulfonate, or a combination thereof, but embodiments are not limited thereto. Examples of the sulfonate compound may include methyl methane sulfonate, ethyl methane sulfonate, diallyl sufonate, or a combination thereof, but embodiments are not limited thereto. The disulfonate compound may be, for example, methylene methane disulfonate (MMDS), busulfan, tosyloxydisulfonate, methylene bismethansulfonate, or a combination thereof, but embodiments are not limited thereto.

As described above, when a lithium metal oxide contains a large amount of Ni, despite the advantages of manufacturing a high capacity battery, as the amount of cation Ni³⁺ increases in a battery, lifespan characteristics of the battery may deteriorate and resistance may increase. As described above, when a disulfonate compound is included, the sulfonate may react with cation Ni³⁺ and stabilize the battery, and thus resistance may decrease. Here, when an amount of the disulfonate compound exceeds about 3 wt % based on the total weight of the electrolyte, the disulfonate moiety of the disulfonate compound may react with lithium cations generated from the positive active material, and thereby consuming the lithium cations may be consumed so that they are no longer available to participate in the battery charge/discharge process.

The phosphate-based compound represented by Formula 2 may be easily decomposed due to a reaction with the negative electrode. As described below, in the lithium secondary battery including a negative active material including a metal alloyable with lithium or a carbonaceous negative active material, the generation of gas occurs due to a catalyst reaction at a high temperature, and as a result the lifespan characteristics of the battery are deteriorated. As described above, when FEC, VC, VEC, a phosphorous-containing compound, a sulfur-containing compound, or a combination thereof is included in the electrolyte at an amount within the above-described ranges, a passivation layer is formed by a chemical reaction between the materials, that is, an SEI film may be formed on a portion of the surface of the negative electrode or on the entire surface of the negative electrode surface. Without being limited by theory, it is understood that gas occurrence may be prevented due to the presence of the SEI film when the lithium secondary battery is stored at a high temperature, and as a result, the battery may have improved safety and performance.

Hereinafter, a structure of the lithium secondary battery will be described in detail.

The positive electrode includes the positive active material represented by Formula 1. In an embodiment, A in Formula 1 may be a halogen, S, or N, but embodiments are not limited thereto.

For example, in Formula 1, y denotes an amount of Ni in the positive active material, and satisfies 0.7≤y≤0.98. For example, in Formula 1, y may satisfy 0.8≤y≤0.98. For example, in Formula 1, y may satisfy 0.8≤y≤0.9. For example, in Formula 1, y may satisfy 0.8≤y≤0.88. When an amount of Ni in the positive active material is less than 70% of the positive active material, the amount of Ni is too small, even though a surface structure of the positive electrode is stable and deterioration of lifespan characteristics, such as elution of cation Ni³⁺ or disproportionation, may occur less than in a Ni-rich positive active material, a phosphate-based compound having an affinity for cation Ni³⁺ attaches instead on a surface of the positive active material, and thus resistance may increase. Due to the increase in resistance, the battery may have a decreased lifespan and deteriorated resistance characteristics.

For example, the positive active material may be represented by Formula 3 or Formula 4:

LiNi_{y′}Co_{1-y′-z′}Al_{z′}O₂, or Formula 3

LiNi_{y′}Co_{1-y′-z′}Mn_{z′}O₂. Formula 4

In Formula 3 and Formula 4, 0.9≤x′≤1.2, 0.8≤y′≤0.98, 0<z′<0.1, and 0<1−y′−z′<0.2.

For example, the positive electrode may include LiNi_{0.8}Co_{0.15}Mn_{0.05}O₂, LiNi_{0.85}Co_{0.1}Mn_{0.05}O₂, LiNi_{0.88}Co_{0.08}Mn_{0.04}O₂, LiNi_{0.88}Co_{0.08}Al_{0.04}O₂, Li_{1.02}Ni_{0.80}Co_{0.15}Mn_{0.05}O₂, Li_{1.02}Ni_{0.85}Co_{0.10}Mn_{0.05}O₂, Li_{1.02}Ni_{0.88}Co_{0.08}Mn_{0.04}O₂, Li_{1.02}Ni_{0.88}Co_{0.08}Al_{0.04}O₂, LiNi_{0.8}Co_{0.15}Al_{0.05}O₂, LiNi_{0.88}Co_{0.1}Al_{0.02}O₂, LiNi_{0.88}Co_{0.12}Mn_{0.04}O₂, LiNi_{0.85}Co_{0.1}Al_{0.05}O₂, and LiNi_{0.88}Co_{0.1}Mn_{0.02}O₂ as a positive active material. For example, the positive electrode may include at least one selected from LiNi_{0.8}Co_{0.15}Mn_{0.05}O₂, LiNi_{0.85}Co_{0.1}Mn_{0.05}O₂, LiNi_{0.88}Co_{0.08}Mn_{0.04}O₂, LiNi_{0.88}Co_{0.08}Al_{0.04}O₂, Li_{1.02}Ni_{0.80}Co_{0.15}Mn_{0.05}O₂, Li_{1.02}Ni_{0.85}Co_{0.10}Mn_{0.05}O₂, Li_{1.02}Ni_{0.88}Co_{0.08}Mn_{0.04}O₂, Li_{1.02}Ni_{0.88}Co_{0.08}Al_{0.04}O₂, or a combination thereof as a positive active material, but embodiments are not limited thereto.

The positive electrode may further include a lithium cobalt oxide, lithium nickel cobalt manganese oxide, lithium nickel cobalt aluminum oxide, lithium iron phosphate, lithium manganese oxide, or a combination thereof, in addition to the foregoing positive active materials, but embodiments of the positive active materials are not limited thereto. Any suitable positive active material available in the art may further be included in the positive electrode.

For example, the positive electrode may further include a positive active material represented by the following formulae: LiₐA_{1-b}B′_{b}D₂ (wherein 0.90≤a≤1.8 and 0≤b≤0.5); LiₐE_{1-b}B′_{b}O_{2-c}D_{c} (wherein 0.90≤a≤1.8, 0≤b≤0.5, and 0≤c≤0.05); LiE_{2-b}B′_{b}O_{4-c}D_{c} (wherein 0≤b≤0.5 and 0≤c≤0.05); LiₐNi_{1-b-c}Co_{b}B′_{c}D_{α} (wherein 0.90≤a≤1.8, 0≤b≤0.5, 0≤c≤0.05, and 0<α≤2); LiₐNi_{1-b-c}Co_{b}B_{c}O_{2-α}F′_{α} (wherein 0.90≤a≤1.8, 0≤b≤0.5, 0≤c≤0.05, and 0<α<2); LiₐNi_{1-b-c}CO_{b}B′_{c}O_{2-α}F′_{α} (wherein 0.90≤a≤1.8, 0≤b≤0.5, 0≤c≤0.05, and 0<α<2); LiₐNi_{1-b-c}Mn_{b}B′_{c}D_{α} (wherein 0.90≤a≤1.8, 0≤b≤0.5, 0≤c≤0.05, and 0<α≤2); LiₐNi_{1-b-c}Mn_{b}B′_{c}O_{2-α}F′_{α} (wherein 0.90≤a≤1.8, 0≤b≤0.5, 0≤c≤0.05, and 0<α<2); LiₐNi_{1-b-c}Mn_{b}B′_{c}O_{2-α}F′_{α} (wherein 0.90≤a≤1.8, 0≤b≤0.5, 0≤c≤0.05, and 0<α<2); LiₐNi_{b}E_{c}G_{d}O₂ (wherein 0.90≤a≤1.8, 0≤b≤0.9, 0≤c≤0.5, and 0.001≤d≤0.1); LiₐNi_{b}Co_{c}Mn_{d}GeO₂ (wherein 0.90≤a≤1.8, 0≤b≤0.9, 0≤c≤0.5, 0≤d≤0.5, and 0.001≤e≤0.1); LiₐNiG_{b}O₂ (wherein 0.90≤a≤1.8 and 0.001≤b≤0.1); LiₐCoG_{b}O₂ (wherein 0.90≤a≤1.8 and 0.001≤b≤0.1); LiₐMnG_{b}O₂ (wherein 0.90≤a≤1.8 and 0.001≤b≤0.1); LiₐMn₂G_{b}O₄ (wherein 0.90≤a≤1.8 and 0.001≤b≤0.1); QO₂; QS₂; LiQS₂; V₂O₅; LiV₂O₅; LiI′O₂; LiNiVO₄; Li_{(3-f)}J₂(PO₄)₃ (wherein 0≤f≤2); Li_{(3-f)}Fe₂(PO₄)₃ (wherein 0≤f≤2); LiFePO₄, or a combination thereof.

In the foregoing formulae, A may include nickel (Ni), cobalt (Co), manganese (Mn), or a combination thereof; B′ may include Al, Ni, Co, Mn, Cr, Fe, magnesium (Mg), strontium (Sr), V, a rare-earth element, or a combination thereof; D may include oxygen (O), fluorine (F), sulfur (S), phosphorus (P), or a combination thereof; E may include Co, Mn, or a combination thereof; F′ may include F, S, P, or a combination thereof; G may include Al, Cr, Mn, Fe, Mg, lanthanum (La), cerium (Ce), Sr, V, or a combination thereof; Q may include Ti, Mo, Mn, or a combination thereof; I′ may include Cr, V, Fe, scandium (Sc), yttrium (Y), or a combination thereof; and J may include V, Cr, Mn, Co, Ni, Cu, or a combination thereof.

A positive electrode may be prepared by the following method.

The positive electrode may be prepared by applying, drying, and pressing a positive electrode active material composition on a positive electrode current collector. In addition to the above-described positive electrode active materials, a positive active material composition in which a binder and a solvent are mixed may be prepared, as desired.

The positive active material composition may further include a conductive agent or a filler.

In one or more embodiments, the positive active material composition may be directly be coated on a metallic current collector and then dried to prepare a positive electrode plate. In one or more embodiments, the positive active material composition may be cast on a separate support to form a positive active material film, which may then be separated from the support and laminated on a metallic current collector to prepare a positive electrode plate.

In some embodiments, a loading level of a prepared positive active material composition may be about 30 milligrams per square centimeter (mg/cm²) or greater, and in some embodiments, about 35 mg/cm² or greater, and in some embodiments, about 40 mg/cm² or greater. In addition, an electrode density of the positive electrode may be about 3 grams per cubic centimeter (g/cc) or greater, and in some embodiments, about 3.5 g/cc or greater.

In an embodiment, in order to achieve a high cell energy density, a loading level of the prepared positive active material composition may be about 35 mg/cm² to about 50 mg/cm², and an electrode density thereof may be about 3.5 g/cc to about 4.2 g/cc.

In another embodiment, both surfaces of the positive electrode plate may be coated with the positive active material composition at a loading level of about 37 mg/cm² and at an electrode density of about 3.6 g/cc.

When a loading level and an electrode density of the positive active material composition are within the above-described ranges, a battery including a positive active material prepared from the positive active material composition the positive active material may have a high cell energy density of about 500 watt-hours per liter (Wh/L) or greater. For example, the battery may have a cell energy density of about 500 Wh/L to about 900 Wh/L.

Examples of the solvent include, but are not limited to, N-methylpyrrolidone (NMP), acetone, and water. An amount of the solvent may be in a range of about 10 parts by weight to about 100 parts by weight based on 100 parts by weight of the negative active material. When the amount of the solvent is within this range, a process for forming the negative active material layer may be performed efficiently.

The conductive agent may be added in an amount of about 1 wt % to about 30 wt % based on a total weight of the positive active material composition. The conductive agent may be any material having suitable electrical conductivity without causing an undesirable chemical change in a battery. Examples of the conductive agent include graphite, such as natural graphite or artificial graphite; a carbonaceous material, such as carbon black, acetylene black, Ketjen black, channel black, furnace black, lamp black, or summer black; conductive fibers, such as carbon fibers or metal fibers; a metal powder of fluorinated carbon, aluminum, or nickel; a conductive whisker, such as zinc oxide or potassium titanate; a conductive metal oxide, such as titanium oxide; and a conductive polymer material, such as a polyphenylene derivative. A combination comprising at least one of the foregoing may also be used.

The binder is a component which may assist in bonding an active material and a conductive agent to a current collector, and may be added in an amount of about 1 wt % to about 30 wt % based on the total weight of the positive active material composition. Examples of the binder may include polyvinylidene fluoride (PVdF), polyvinylidene chloride, polybenzimidazole, polyimide, polyvinyl acetate, polyacrylonitrile, polyvinyl alcohol, carboxymethyl cellulose (CMC), starch, hydroxypropyl cellulose, regenerated cellulose, polyvinyl pyrrolidone, tetrafluoro ethylene, polyethylene, polypropylene, polystyrene, polymethyl methacrylate, polyaniline, acrylonitrile butadiene styrene, phenol resin, epoxy resin, polyethylene terephthalate, polytetrafluoroethylene, polyphenyl sulfide, polyamideimide, polyetherimide, polyether sulfone, polyamide, polyacetal, polyphenylene oxide, polybutylene terephthalate, an ethylene-propylene-diene monomer (EPDM), a sulfonated EPDM, a styrene-butadiene rubber, a fluorine rubber, various suitable copolymers thereof, or a combination thereof. The filler may optionally be included in the positive active material composition as a component for suppressing expansion of a positive electrode. The filler may not be particularly limited, and may be any suitable fibrous material which does not cause an undesirable chemical change in a battery. For example, a fibrous material, such as an olefin polymer, e.g., polyethylene or polypropylene; glass fibers; or carbon fibers, may be used as a filler.

Amounts of the positive active material, the conductive agent, the filler, the binder, and the solvent may be determined by those of skill in the art without undue experimentation. At least one of the conductive agent, the filler, the binder, and the solvent may be omitted according to a desired use and a structure of a lithium battery.

In some embodiments, NMP may be used as a solvent, PVdF or a PVdF copolymer may be used as a binder, and carbon black or acetylene black may be used as a conductive agent. For example, 94 wt % of a positive active material, 3 wt % of a binder, and 3 wt % of a conductive agent may be mixed in powder form, and then NMP may be added thereto such that a slurry is formed with a solid content of 70 wt %. This slurry may then be coated, dried, and rolled to prepare a positive electrode plate.

The positive electrode current collector may be, in general, prepared to have a thickness in a range of about 3 micrometers (μm) to about 50 μm. The positive electrode current collector is not particularly limited, and may be any suitable material as long as the positive electrode current collector has suitable electrical conductivity without causing an undesirable chemical change in a battery. Examples of the positive electrode current collector include stainless steel, aluminum, nickel, titanium, and sintered carbon; and aluminum or stainless steel, the aluminum and the stainless steel each being surface-treated with carbon, nickel, titanium, silver, or a combination thereof. The positive electrode current collector may be processed to have fine bumps on surfaces thereof so as to enhance binding of the positive active material to the current collector. The positive electrode current collector may be used in any of various suitable forms including a film, a sheet, a foil, a net, a porous structure, a foam, and a non-woven fabric.

In some embodiments, the negative electrode may include a negative active material including a metal alloyable with lithium and/or a carbonaceous negative active material.

In some embodiments, the negative active material including a metal alloyable with lithium may include silicon (Si), a silicon-carbon composite material including Si particles, SiO_{a′} (wherein 0<a′<2), or a combination thereof.

In some embodiments, the Si particles in the silicon-carbon composite material may have an average diameter of 200 nanometers (nm) or less.

For example, a capacity of the Si—C composite material may be in a range of about 600 milliampere hours per gram (mAh/g) to about 2,000 mAh/g. For example, a capacity of the Si—C composite material may be in a range of about 800 mAh/g to about 1,600 mAh/g.

For example, SiO_{a′} or the Si—C composite material may be used in combination with a graphite material. For example, 12% of a Si—C composite material having a capacity of 1,300 mAh/g, 85% of graphite, and 3% of a binder may be used to constitute a negative electrode having a capacity of 500 mAh/g, and the performance of a battery prepared by using the negative electrode is better than the performance of a battery prepared by using SiO_{a′} or a Si—C composite material having a capacity of 500 mAh/g.

Examples of the negative active material include, in addition to the aforementioned negative active materials, tin (Sn), Al, germanium (Ge), lead (Pb), Bi, Sb, a Si—Y′ alloy (wherein Y′ may be an alkali metal, an alkaline earth-metal, a Group XIII element, a Group XIV element, a transition metal, a rare-earth element, or a combination thereof, and Y′ may not be Si), and a Sn—Y′ alloy (wherein Y′ may be an alkali metal, an alkaline earth-metal, a Group XIII element, a Group XIV element, a transition metal, a rare-earth element, or a combination thereof, and Y may not be Sn). Y′ may be Mg, Ca, Sr, barium (Ba), radium (Ra), Sc, Y, Ti, Zr, hafnium (Hf), rutherfordium (Rf), V, Nb, tantalum (Ta), dubnium (Db), Cr, Mo, W, seaborgium (Sg), technetium (Tc), rhenium (Re), bohrium (Bh), Fe, Pb, ruthenium (Ru), osmium (Os), hassium (Hs), rhodium (Rh), iridium (Ir), palladium (Pd), platinum (Pt), Cu, silver (Ag), gold (Au), Zn, cadmium (Cd), B, Al, gallium (Ga), Sn, In, Ge, P, arsenic (As), Sb, Bi, S, selenium (Se), tellurium (Te), polonium (Po), or a combination thereof.

A negative electrode may be prepared by the following method.

The negative electrode may be prepared by applying, drying, and pressing a negative electrode active material composition on a negative electrode current collector. In addition to the above-described negative electrode active materials, a negative active material composition in which a binder and a solvent are combined may be prepared, if desired.

The negative active material composition may further include a conductive agent or a filler.

In one or more embodiments, the binder, the solvent, the conductive agent, and the filler used for the positive active material composition may also be used for the negative active material composition.

In the negative active material composition, water may be used as a solvent. For example, water may be used as a solvent, CMC or SBR, acrylate, and methacrylate copolymers may be used as a binder, and carbon black, acetylene black, and graphite may be used as a conductive agent. For example, 94 wt % of a negative active material including a Si—C composite material and graphite, 3 wt % of a binder, and 3 wt % of a conductive agent may be combined together in powder form, and water is added thereto to prepare a slurry having a solids content of 70 wt %. Then, the slurry may be coated, dried, and pressed on a negative electrode current collector to prepare a negative electrode plate.

A loading level of the negative active material thus prepared may be determined according to a desired loading level of the positive active material.

For example, a capacity of the negative active material composition per gram may be from about 12 mg/cm², in other embodiments, from about 15 mg/cm². Also, an electrode density of the negative active material composition may be from about 1.5 g/cc, in other embodiments, from about 1.6 g/cc. The capacity per gram may change by controlling a ratio of a Si—C composite material to graphite. For example, a maximum capacity of graphite is about 360 mAh/g, and when the negative active material composition includes 84% of graphite, 14% of a Si—C composite material having a capacity of 1,300 mAh/g, and 2% of a binder, the negative electrode may exhibit a capacity of about 500 mAh/g. When the Si—C composite material is mixed with SiO_{a′}, a capacity of the negative electrode may be in a range of about 380 mAh/g to about 800 mAh/g. When the capacity is about 380 mAh/g or less, the mixing has no effect, and when the capacity is higher than about 800 mAh/g, a retention ratio may be deteriorated.

In an embodiment, in order to achieve a high cell energy density, a loading level of the prepared negative active material composition may be about 15 mg/cm² to about 25 mg/cm², and an electrode density thereof may be about 1.6 g/cc to about 2.3 g/cc.

When a loading level and an electrode density of the negative active material composition are within any of the above-described ranges, a battery including a negative active material prepared from the negative active material composition may have a high cell energy density of about 500 Wh/L or greater.

The negative electrode current collector may be, in general, prepared to have a thickness in a range of about 3 μm to about 50 μm. The negative electrode current collector is not particularly limited, and may be any suitable material as long as the negative electrode current collector has suitable electrical conductivity without causing an undesirable chemical change in a battery. Examples of the negative electrode current collector may include copper, stainless steel, aluminum, nickel, titanium, or sintered carbon; copper or stainless steel surface-treated with carbon, nickel, titanium, or silver; or an aluminum-cadmium alloy, or a combination thereof. In addition, like the positive electrode current collector, the negative electrode current collector may be processed to have fine bumps on surfaces of the negative electrode current collector in order to enhance binding of the negative active material to the current collector. The negative electrode current collector may be used in any of various suitable forms including a film, a sheet, a foil, a net, a porous structure, a foam, and a non-woven fabric.

In an embodiment, the lithium secondary battery may have a direct current internal resistance (DCIR) increase rate of about 150% or lower after 300 charging/discharging cycles at a temperature of 45° C. under conditions including a charging/discharging current of 0.3 C to 1 C/0.3 C to 1 C, a driving voltage in a range of about 2.8 V to about 4.3 V, for example, about 2.8 V to about 4.2 V, and a CC-CV 1/10C cut-off.

That is, as compared with Ni-rich lithium secondary batteries, the lithium secondary battery disclosed herein may have a significantly low increase in DCIR. Accordingly, the lithium secondary battery may exhibit excellent battery characteristics.

For example, an operating voltage of the lithium secondary battery may be in a range of about 2.8 V to about 4.2 V, or about 2.8 V to about 4.3 V.

For example, an energy density of the lithium secondary battery may be about 500 Wh/L or greater.

In an embodiment, the lithium secondary battery may further include a separator between the positive electrode and the negative electrode. The separator may be an insulating thin film having excellent ion permeability and mechanical strength. The separator may have a pore diameter in a range of about 0.001 μm to about 1 μm, and a thickness thereof may be in a range of about 3 μm to about 30 μm. Examples of the separator include a chemically resistant and hydrophobic olefin-based polymer, e.g., polypropylene; and a sheet or non-woven fabric formed of glass fiber or polyethylene. When a solid electrolyte is used as an electrolyte, the solid electrolyte may serve as a separator.

The electrolyte may further include, in addition to the foregoing electrolyte, a solid electrolyte and an inorganic solid electrolyte.

Examples of the organic solid electrolyte include a polyethylene derivative, a polyethylene oxide derivative, a polypropylene oxide derivative, a phosphoric acid ester polymer, polyester sulfide, a polyvinyl alcohol, PVdF, a polymer including a dissociable ionic group, or a combination thereof.

Examples of the inorganic solid electrolyte include a lithium nitride, such as Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, or Li₃PO₄—Li₂S—SiS₂; a halide; a sulfate, or a combination thereof.

The lithium secondary battery may be prepared by a known method, for example, the lithium secondary battery may be prepared by injecting an electrolyte between a positive electrode and a negative electrode.

The aforementioned positive electrode, negative electrode, and separator may be wound or folded, and then sealed in a battery case. Then, the battery case may be filled with an electrolyte and then sealed by a cap assembly member, to thereby complete the preparation of a lithium secondary battery. The battery case may be a cylindrical type, a rectangular type, or a thin-film type.

The lithium secondary battery may be classified as a winding type or a stack type depending on a structure of electrodes, or as a cylindrical type, a rectangular type, a coin type, or a pouch type, depending on an exterior shape thereof.

Methods of manufacturing a lithium secondary battery are known to those of skill the art and thus a detailed description thereof is omitted.

According to an aspect, a battery module may include the lithium secondary battery as a unit cell.

According to another aspect, a battery pack may include the battery module.

According to still another aspect, a device may include the battery pack. Examples of the device include a power tool powered by an electric motor; an electric car, e.g., an electric vehicle (EV), a hybrid electric vehicle (HEV), a plug-in hybrid electric vehicle (PHEV); an electric two-wheeled vehicle, e.g., an e-bike and an e-scooter; an electric golf cart; and a power storage system. However, embodiments of the device are not limited thereto.

In addition, the lithium secondary battery may be used in any applications that benefit from high-power output and a high voltage, and operate under high-temperature conditions.

One or more embodiments will now be described in more detail with reference to the following examples. However, these examples are provided for illustrative purposes only and should not be construed as limiting the scope of the one or more embodiments.

### EXAMPLES

### Example 1

### (Preparation of Positive Electrode)

LiNi_{0.8}Co_{0.15}Mn_{0.05}O₂, as a positive active material; carbon black, as a conductive agent; and PVdF, as a binder, were added in a weight ratio of 94:3:3 to NMP and mixed to prepare a mixture. Subsequently, the mixture was dispersed and coated onto both surfaces of an aluminum foil having a thickness of about 16 μm, wherein a surface area of each of the two surfaces was 37 milligrams per square centimeter (mg/cm²). The aluminum foil was then dried and roll-pressed to prepare a positive electrode having an electrode density of 3.6 grams per cubic centimeter (g/cc).

### (Preparation of Negative Electrode)

Graphite, CMC, and SBR were added in a weight ratio of 98:1.5:0.5 to NMP and mixed and dispersed therein to prepare a mixture. Subsequently, the mixture was dispersed and coated onto both surfaces of a copper foil having a thickness of about 10 micrometers (μm), wherein a surface area of each of the two surfaces was 21.86 mg/cm². The copper foil was then dried and roll-pressed to prepare a negative electrode having an electrode density of 1.65 g/cc.

### (Preparation of Electrolyte)

1.5 wt % of VC and 1 wt % of TMP were added to 1.15 M of LiPF₆ and EC/EMC/DMC (at a volume ratio of 2:4:4) based on the total weight of an electrolyte to prepare an electrolyte.

### (Preparation of Lithium Secondary Battery)

A separator formed of polypropylene having a thickness of 16 μm was disposed between the positive electrode and the negative electrode, and the electrolyte was injected thereto, thereby completing the manufacture of a lithium secondary battery.

### Example 2

A lithium secondary battery was prepared in the same manner as in Example 1, except that TMP was added at an amount of 2 wt % instead of 1 wt % to prepare the electrolyte.

### Example 3

A lithium secondary battery was prepared in the same manner as in Example 1, except that LiNi_{0.85}Co_{0.1}Mn_{0.05}O₂ was used instead of LiNi_{0.8}Co_{0.15}Mn_{0.05}O₂ as a positive active material.

### Example 4

A lithium secondary battery was prepared in the same manner as in Example 1, except that LiNi_{0.85}Co_{0.1}Mn_{0.04}O₂ was used instead of LiNi_{0.8}Co_{0.15}Mn_{0.05}O₂ as a positive active material.

### Example 5

A lithium secondary battery was prepared in the same manner as in Example 4, except that 1 wt % of triphenylphosphate (TPP) was used instead of 1 wt % of TMP.

### Example 6

A lithium secondary battery was prepared in the same manner as in Example 1, except that LiNi_{0.88}Co_{0.08}Al_{0.04}O₂ was used instead of LiNi_{0.8}Co_{0.15}Mn_{0.05}O₂ as a positive active material.

### Example 7

A lithium secondary battery was prepared in the same manner as in Example 6, except that 1 wt % of TPP was used instead of 1 wt % of TMP.

### Comparative Example 1

A lithium secondary battery was prepared in the same manner as in Example 1, except that 1 wt % of TMP was not added to prepare the electrolyte.

### Comparative Example 2

A lithium secondary battery was prepared in the same manner as in Example 1, except that LiNi_{0.6}Co_{0.2}Mn_{0.2}O₂ was used instead of LiNi_{0.8}Co_{0.15}Mn_{0.05}O₂, and 2 wt % of TMP was added instead of 1 wt % of TMP to prepare the electrolyte.

### Comparative Example 3

A lithium secondary battery was prepared in the same manner as in Example 1, except that 3 wt % of TPP was used instead of 1 wt % of TMP.

### Example 8

### (Preparation of Positive Electrode)

The positive electrode prepared in Example 1 was used.

### (Preparation of Negative Electrode)

SCN (an active material that is designed to exhibit a capacity of 1300 mAh/g by carbon coating graphite after dispersing Si particles having an average particle diameter of 100 nm on the graphite), graphite, CMC, and SBR were added in a weight ratio of 14:84:1.5:0.5 to NMP and mixed to prepare a mixture. Subsequently, the mixture was dispersed and coated onto both surfaces of a copper foil having a thickness of about 10 μm, wherein a surface area of each of the both surfaces was 16.5 mg/cm². The copper foil was then dried and roll-pressed to prepare a negative electrode having an electrode density of 1.65 g/cc. Here, SCN had Si particles on graphite.

### (Preparation of Electrolyte)

1.5 wt % of VC and 1 wt % of TMP were added to 1.15 M of LiPF₆ and FEC/EC/EMC/DMC (at a volume ratio of 7:7:46:40) based on the total weight of an electrolyte to prepare an electrolyte.

### (Preparation of Lithium Secondary Battery)

A separator formed of polypropylene having a thickness of 16 microns was disposed between the positive electrode and the negative electrode, and the electrolyte was injected thereto, thereby completing the manufacture of a lithium secondary battery.

### Example 9

A lithium secondary battery was prepared in the same manner as in Example 8, except that 2 wt % of TMP was added instead of 1 wt % of TMP to prepare the electrolyte.

### Example 10

A lithium secondary battery was prepared in the same manner as in Example 8, except that LiNi_{0.85}Co_{0.1}Mn_{0.05}O₂ was used instead of LiNi_{0.8}Co_{0.15}Mn_{0.05}O₂ as a positive active material.

### Example 11

A lithium secondary battery was prepared in the same manner as in Example 8, except that LiNi_{0.85}Co_{0.1}Mn_{0.04}O₂ was used instead of LiNi_{0.8}Co_{0.15}Mn_{0.05}O₂ as a positive active material.

### Example 12

A lithium secondary battery was prepared in the same manner as in Example 11, except that 1 wt % of TPP was used instead of 1 wt % of TMP.

### Example 13

A lithium secondary battery was prepared in the same manner as in Example 8, except that LiNi_{0.88}Co_{0.08}Al_{0.04}O₂ was used instead of LiNi_{0.8}Co_{0.15}Mn_{0.05}O₂ as a positive active material.

### Example 14

A lithium secondary battery was prepared in the same manner as in Example 13, except that 1 wt % of TPP was used instead of 1 wt % of TMP.

### Comparative Example 4

A lithium secondary battery was prepared in the same manner as in Example 8, except that 1 wt % of TMP was not added to prepare the electrolyte.

### Comparative Example 5

A lithium secondary battery was prepared in the same manner as in Example 8, except that LiNi_{0.6}Co_{0.2}Mn_{0.2}O₂ was used instead of LiNi_{0.8}Co_{0.15}Mn_{0.05}O₂ as a positive active material, and 2 wt % of TMP was added instead of 1 wt % of TMP.

### Comparative Example 6

A lithium secondary battery was prepared in the same manner as in Example 8, except that 3 wt % of TPP was used instead of 1 wt % of TMP.

### Example 15

### (Preparation of Positive Electrode)

The positive electrode prepared in Example 1 was used.

### (Preparation of Negative Electrode)

The negative electrode prepared in Example 8 was used.

### (Preparation of Electrolyte)

1 wt % of VC, 0.3 wt % of maleic anhydride (MA), and 1 wt % of TMP were added to 1.15 M of LiPF₆ and FEC/EC/EMC/DMC (at a volume ratio of 7:7:46:40) based on the total weight of an electrolyte to prepare an electrolyte.

### (Preparation of Lithium Secondary Battery)

A separator formed of polypropylene having a thickness of 16 microns was disposed between the positive electrode and the negative electrode, and the electrolyte was injected thereto, thereby completing the manufacture of a lithium secondary battery.

### Example 16

A lithium secondary battery was prepared in the same manner as in Example 15, except that 2 wt % of TMP was used instead of 1 wt % of TMP to prepare the electrolyte.

### Example 17

A lithium secondary battery was prepared in the same manner as in Example 15, except that LiNi_{0.85}Co_{0.1}Mn_{0.05}O₂ was used instead of LiNi_{0.8}Co_{0.15}Mn_{0.05}O₂ as a positive active material.

### Example 18

A lithium secondary battery was prepared in the same manner as in Example 15, except that LiNi_{0.88}Co_{0.08}Mn_{0.04}O₂ was used instead of LiNi_{0.8}Co_{0.15}Mn_{0.05}O₂ as a positive active material.

### Example 19

A lithium secondary battery was prepared in the same manner as in Example 18, except that 1 wt % of TPP was used instead of 1 wt % of TMP.

### Example 20

A lithium secondary battery was prepared in the same manner as in Example 15, except that 0.3 wt % of MMDS based on the total weight of the electrolyte was further added to prepare the electrolyte. The structure of MMDS is shown below.

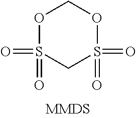

### Example 21

A lithium secondary battery was prepared in the same manner as in Example 20, except that 2 wt % of TMP was added instead of 1 wt % of TMP to prepare the electrolyte.

### Example 22

A lithium secondary battery was prepared in the same manner as in Example 20, except that LiNi_{0.85}Co_{0.1}Mn_{0.05}O₂ was used instead of LiNi_{0.8}Co_{0.15}Mn_{0.05}O₂ as a positive active material.

### Example 23

A lithium secondary battery was prepared in the same manner as in Example 20, except that LiNi_{0.88}Co_{0.08}Mn_{0.04}O₂ was used instead of LiNi_{0.8}Co_{0.15}Mn_{0.05}O₂ as a positive active material.

### Example 24

A lithium secondary battery was prepared in the same manner as in Example 15, except that 1 wt % of tris(2,2,2-trifluoroethyl)phosphate (TFEP) was used instead of 1 wt % of TMP.

### Comparative Example 7

A lithium secondary battery was prepared in the same manner as in Example 15, except that 1 wt % of TEPi based on the total weight of the electrolyte was further added to prepare the electrolyte.

### Evaluation Example 1: Lifespan and Resistance Evaluation

### (1) When Negative Active Material is Graphite, and Additive Includes Phosphate Compound and VC.

The lithium secondary batteries prepared in Examples 1 to 7 and Comparative Examples 1 to 3 each underwent 300 charging/discharging cycles at 45° C. under conditions including a charging/discharging current of 1C/1C, a driving voltage in a range of about 2.8 V to about 4.3 V, and CC-CV 1/10C cut-off, and then a DCIR increase rate and lifespan characteristics of each of the batteries were measured. The results are shown in Table 1. Here, lifespan characteristics were determined by calculating a ratio of a capacity of the battery after the 300 charging/discharging cycles based on a capacity of the battery after an initial charging/discharging cycle under the same conditions.

lifespan=capacity after 300^{th} charge/discharge cycle/capacity after 1^{st} charge/discharge cycle×100%

DCIR increase=DCIR after 300^{th} charge/discharge cycle/DCIR after 1^{st} charge/discharge cycle×100%

TABLE 1

| | Lifespan (%) | DCIR increase (%) |
|---|---|---|
| Example 1 | 87 | 128 |
| Example 2 | 87 | 130 |
| Example 3 | 86 | 134 |
| Example 4 | 84 | 138 |
| Example 5 | 83 | 142 |
| Example 6 | 83 | 136 |
| Example 7 | 83 | 137 |
| Comparative | 82 | 162 |
| Example 1 | | |
| Comparative | 81 | 159 |
| Example 2 | | |
| Comparative | 67 | 186 |
| Example 3 | | |

As shown in Table 1, the lithium secondary battery including the electrolyte including the phosphate-based compound of one of Examples 1 to 7 exhibited excellent lifespan characteristics and a decreased DCIR increase ratio compared to those of the battery of Comparative Example 1 not including a phosphate-based compound. Also, when TMP or triphenyl phosphate was used as a phosphate-based compound, in both cases, the batteries had excellent lifespan characteristics and a DCIR increase ratio of about 150% or lower.

It is deemed that this resulted because a stable protecting layer is formed due to a phosphate-based compound on a negative electrode surface including graphite, and thus, in spite of repeating charging/discharging processes, electrochemical characteristics of the negative electrode were maintained.

The battery of Comparative Example 2 using a positive electrode containing a small amount of Ni had a decreased lifespan and an increased DCIR increase ratio, compared to those of the batteries of Examples 1 to 7.

Also, in a case of the battery containing a large amount of phosphate prepared in Comparative Example 3, the battery had a decreased lifespan and an increased DCIR increase ratio compared to those of the batteries of Examples 1 to 7. It is deemed that this may have resulted because self-decomposition of the phosphate-based compound occurred significantly, and thus thin film resistance was increased, which resulted in deterioration of battery capacity, storage stability, and cycle characteristics when an amount of the phosphate-based compound in the electrolyte is 3 wt % or higher.

### (2) When Negative Active Material is Silicon (Si), and an Additive Includes Phosphate-Based Compound, VC, and FEC.

The lithium secondary batteries prepared in Examples 8 to 14 and Comparative Examples 4 to 6 each underwent 300 charging/discharging cycles at 45° C. under conditions including a charging/discharging current of 1C/1C, a driving voltage in a range of about 2.8 V to about 4.3 V, and CC-CV 1/10C cut-off, and then a DCIR increase ratio and lifespan characteristics of each of the batteries were measured. The results are shown in Table 2. Here, lifespan characteristics were determined by calculating a ratio of a capacity of the battery after the 300 charging/discharging cycles based on a capacity of the battery after an initial charging/discharging cycle under the same conditions.

TABLE 2

| | Lifespan | DCIR increase |
|---|---|---|
| | (%) | ratio (%) |
| Example 8 | 83 | 131 |
| Example 9 | 83 | 133 |
| Example 10 | 82 | 132 |
| Example 11 | 81 | 133 |
| Example 12 | 80 | 139 |
| Example 13 | 80 | 136 |
| Example 14 | 80 | 134 |
| Comparative | 81 | 157 |
| Example 4 | | |
| Comparative | 76 | 164 |
| Example 5 | | |
| Comparative | 60 | 178 |
| Example 6 | | |

As shown in Table 2, the lithium secondary battery including the electrolyte including the phosphate-based compound of one of Examples 8 to 14 exhibited excellent lifespan characteristics and a decreased DCIR increase ratio compared to those of the battery of Comparative Example 4 not including a phosphate-based compound. Also, when trimethyl phosphate or triphenyl phosphate was used as a phosphate-based compound, in both cases, the batteries had excellent lifespan characteristics and a DCIR increase ratio of about 150% or lower.

It is deemed that, as well as in the case of the graphite negative electrode, this resulted because a stable protecting layer is formed due to a phosphate-based compound on a negative electrode surface including Si and a graphite composite material, and thus, in spite of repeating charging/discharging processes, electrochemical characteristics of the negative electrode were maintained.

The battery of Comparative Example 5 using a positive electrode containing a small amount of Ni had a decreased lifespan and an increased DCIR increase ratio, compared to those of the batteries of Examples 8 to 14.

Also, in a case of the battery containing a large amount of phosphate prepared in Comparative Example 6, the battery had a decreased lifespan and an increased DCIR increase ratio compared to those of the batteries of Examples 8 to 14. Without being limited by theory, it is believed that this may have resulted because when an amount of the phosphate-based compound in the electrolyte is 3 wt % or higher, significant self-decomposition of the phosphate-based compound occurred, and thus thin film resistance was increased and CO₂ thus produced had a negative influence thereon, which resulted in a commensurate deterioration of battery capacity, storage stability, and cycle characteristics.

### (3) When a Negative Active Material is Si and a Graphite Composite Material, and an Additive Includes Phosphate Compound, VC, FEC, and MA.

The lithium secondary batteries prepared in Examples 15 to 24 and Comparative Example 7 each underwent 300 charging/discharging cycles at 45° C. under conditions including a charging/discharging current of 1C/1C, a driving voltage in a range of about 2.8 V to about 4.3 V, and CC-CV 1/10C cut-off, and then a DCIR increase rate and lifespan characteristics of each of the batteries were measured. The results are shown in Table 3. Here, lifespan characteristics were determined by calculating a ratio of a capacity of the battery after the 300 charging/discharging cycles based on a capacity of the battery after an initial charging/discharging cycle under the same conditions.

TABLE 3

| | Lifespan | DCIR increase |
|---|---|---|
| | (%) | ratio (%) |
| Example 15 | 84 | 128 |
| Example 16 | 84 | 128 |
| Example 17 | 84 | 127 |
| Example 18 | 82 | 126 |
| Example 19 | 81 | 132 |
| Example 20 | 84 | 118 |
| Example 21 | 84 | 119 |
| Example 22 | 84 | 117 |
| Example 23 | 82 | 117 |
| Example 24 | 80 | 141 |
| Comparative | 79 | 161 |
| Example 7 | | |

As shown in Table 3, the lithium secondary batteries of Examples 15 to 24 all exhibited excellent lifespan characteristics and a DCIR increase ratio of about 150% or lower. Particularly, the batteries of Examples 21 to 23 further including MMDS in the electrolyte had a low DCIR increase rate of about 130% or lower. Without being limited by theory, it is believed that when the electrolyte includes MMDS, MMDS reacts with cation Ni³⁺, which stabilizes the cation Ni³⁺ and results in decrease in resistance.

As in Comparative Example 7, when a phosphite-based compound is used together with a phosphate-based compound, a retention ratio may decrease. Without being limited by theory, it is understood that this result is due to an increase in resistance.

As described above, according to one or more embodiments, when an amount of Ni in a positive active material increases, a capacity of a battery may be maximized, and a phosphate compound may be included in an electrolyte to improve lifespan characteristics and resistance characteristics of a lithium secondary battery including the positive active material.

It should be understood that embodiments described herein should be considered in a descriptive sense only and not for purposes of limitation. Descriptions of features or aspects within each embodiment should be considered as available for other similar features or aspects in other embodiments.

While one or more embodiments have been described with reference to the figures, it will be understood by those of ordinary skill in the art that various changes in form and details may be made therein without departing from the spirit and scope as defined by the following claims.

What is claimed is:

1. A lithium secondary battery, comprising:
a positive electrode;
a negative electrode; and
an electrolyte disposed between the positive electrode and the negative electrode,
wherein the positive electrode comprises a positive electrode active material represented by Formula 1,
the electrolyte comprises a lithium salt, a non-aqueous solvent, and a phosphate compound represented by Formula 2, and
an amount of the phosphate compound is less than 3 weight percent based on a total weight of the electrolyte,
LiₓNi_{y}M_{1-y}O_{2-z}A_{z}, Formula 1
wherein, in Formula 1,
0.9≤x≤1.2, 0.7≤y≤0.98, and 0≤z<0.2,
M comprises Al, Mg, Mn, Co, Fe, Cr, V, Ti, Cu, B, Ca, Zn, Zr, Nb, Mo, Sr, Sb, W, Bi, or a combination thereof, and
A is an element having an oxidation number of −1 or −2, 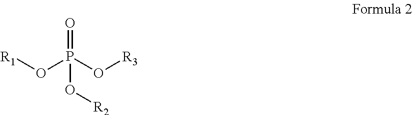
wherein, in Formula 2, R₁ to R₃ are each independently an unsubstituted linear or branched C₁-C₃₀ alkyl group or an unsubstituted C₆-C₆₀ aryl group.

2. The lithium secondary battery of claim 1, wherein an amount of the phosphate compound is about 0.1 weight percent or more to less than about 3 weight percent, based on the total weight of the electrolyte.

3. The lithium secondary battery of claim 1, wherein the phosphate compound comprises trimethyl phosphate, triethyl phosphate, tri(2,2,2-trifluoroethyl)phosphate, tri(3,3,3,2,2-pentafluoropropyl)phosphate, triphenyl phosphate, or a combination thereof.

4. The lithium secondary battery of claim 1, wherein the lithium salt comprises lithium difluoro(oxalato)borate, lithium bis(oxalato)borate, lithium difluorobis(oxalato)borate, LiBF₄, LiPF₆, LiCF₃SO₃, (CF₃SO₂)₂NLi, (FSO₂)₂NLi, or a combination thereof.

5. The lithium secondary battery of claim 1, wherein the non-aqueous solvent comprises dimethyl carbonate, diethyl carbonate, ethyl methyl carbonate, dipropyl carbonate, methyl propyl carbonate, ethyl propyl carbonate, methyl ethyl carbonate, ethylene carbonate, propylene carbonate, butylene carbonate, or a combination thereof.

6. The lithium secondary battery of claim 1, wherein the non-aqueous solvent comprises fluoroethylene carbonate.

7. The lithium secondary battery of claim 6, wherein an amount of the fluoroethylene carbonate is about 0.1 volume percent to about 10 volume percent, based on the total volume of the non-aqueous solvent.

8. The lithium secondary battery of claim 1, wherein the electrolyte comprises a cyclic carbonate comprising a carbon-carbon double bond, a cyclic carboxylic acid anhydride comprising a carbon-carbon double bond, or a combination thereof.

9. The lithium secondary battery of claim 1, wherein the electrolyte further comprises vinylene carbonate vinyl ethylene carbonate, maleic anhydride, succinic anhydride, or a combination thereof.

10. The lithium secondary battery of claim 9, wherein an amount of the vinylene carbonate, the maleic anhydride, or the combination thereof is about 0.1 weight percent to about 3 weight percent, based on the total weight of the electrolyte.

11. The lithium secondary battery of claim 1, wherein the electrolyte further comprises a phosphorus-containing compound, a sulfur-containing compound, or a combination thereof in an amount of about 0.5 weight percent to about 2 weight percent, based on the total weight of the electrolyte.

12. The lithium secondary battery of claim 11, wherein the sulfur-containing compound is methylene methane disulfonate, busulfan, tosyloxydisulfonate, methylene bis methansulfonate, or a combination thereof.

13. The lithium secondary battery of claim 1, wherein, in Formula 1, 0.8≤y≤0.98.

14. The lithium secondary battery of claim 1, wherein the positive active material is represented by Formula 3 or Formula 4:
Li_{x′}Ni_{y′}Co_{1-y′-z′}Al_{z′}O₂, or Formula 3
Li_{x′}Ni_{y′}Co_{1-y′-z′}Mn_{z′}O₂, Formula 4
wherein, in Formula 3 and Formula 4, 0.9≤x′≤1.2, 0.8≤y′≤0.98, 0≤z′<0.1, and 0<1−y′−z′<0.2.

15. The lithium secondary battery of claim 1, wherein the positive electrode comprises LiNi_{0.8}Co_{0.15}Mn_{0.05}O₂, LiNi_{0.85}Co_{0.1}Mn_{0.05}O₂, LiNi_{0.88}Co_{0.08}Mn_{0.04}O₂, LiNi_{0.88}Co_{0.08}Al_{0.04}O₂, Li_{1.02}Ni_{0.80}Co_{0.15}Mn_{0.05}O₂, Li_{1.02}Ni_{0.85}Co_{0.10}Mn_{0.05}O₂, Li_{1.02}Ni_{0.88}Co_{0.08}Mn_{0.04}O₂, Li_{1.02}Ni_{0.88}Co_{0.08}Al_{0.04}O₂, or a combination thereof.

16. The lithium secondary battery of claim 1, wherein the negative electrode comprises a negative active material comprising a metal alloyable with lithium, a carbonaceous negative active material, or a combination thereof.

17. The lithium secondary battery of claim 16, wherein the negative active material comprising a metal alloyable with lithium comprises silicon, a silicon-carbon composite material comprising, SiO_{a′} (0<a′<2), or a combination thereof.

18. The lithium secondary battery of claim 16, wherein the carbonaceous negative active material comprises graphite.

19. The lithium secondary battery of claim 1, wherein the lithium secondary battery has a direct current internal resistance increase rate of 150% or less after 300 charge/discharge cycles at a temperature of 45° C.

20. The lithium secondary battery of claim 1, wherein a cell energy density is about 500 Watt hours per liter or greater.
